(19) United States
(12) Patent Application Publication
(10) Pub. No.: US 2011/0049977 A1
(43) Pub. Date: Mar. 3, 2011

(54) SAFETY AND PERFORMANCE OPTIMIZED CONTROLS FOR LARGE SCALE ELECTRIC VEHICLE BATTERY SYSTEMS

(75) Inventors: Per Onnerud, Framingham, MA (US); Jan-Roger Linna, Boston, MA (US); John Warner, Shrewsbury, MA (US); Chad Souza, North Providence, RI (US)

(73) Assignee: Boston-Power, Inc., Westborough, MA (US)

(21) Appl. No.: 12/872,494

(22) Filed: Aug. 31, 2010

Related U.S. Application Data
(60) Provisional application No. 61/338,990, filed on Feb. 26, 2010.
(60) Provisional application No. 61/238,961, filed on Sep. 1, 2009.

(51) Int. Cl. B60L 1/00

(52) U.S. Cl. 307/9.1

(57) ABSTRACT

An electric vehicle power system including a battery system, a bus configured to transfer power to a motor drive, and a control circuit to selectively couple the battery to the bus. The control circuit is discharges capacitance of the bus to a chassis in response to a disconnect between the battery and the bus. Further, the control circuit measures impedance across the bus. As a result, the control circuit can monitor integrity of the bus and detect a fault, such as a short circuit or degraded bus insulation.

### RELATED APPLICATION(S)

This application claims the benefit of U.S. Provisional Application No. 61/338,990, filed Feb. 26, 2010 (Attorney Docket No. 3853.1047-001) and U.S. Provisional Application No. 61/238,961, filed Sep. 1, 2009 (Attorney Docket No. 3853.1047-000). The entire teachings of the above applications are incorporated herein by reference.

### BACKGROUND OF THE INVENTION

Large scale battery systems are used as power storage devices for a variety of electric and hybrid electric vehicles. A few examples of vehicles that can be driven with electric or hybrid electric power would be automobiles, boats, and trolley cars. These battery systems typically range in capacity from 10 kWh up to 100 kWh and will typically have nominal voltage ratings ranging from 44.4VDC to 444VDC.

In these large scale battery systems mechanical and electronic controls must be designed to optimize performance and safety. If these controls are designed and implemented properly the pack will have performance and safety characteristics approaching that of the individual cells it contains. The battery management system (BMS) control electronics' architecture is a master/slave type distributed processing system. The system contains a single master processor, hereafter referred to as the BMS Host Controller (BMSHC). Each module as shown in FIG. 1 also contains a generic microcontroller or an application specific integrated circuit (ASIC), hereinafter referred to as the “module controller” or “module ASIC”, that performs the share function.

### SUMMARY OF THE INVENTION

Current large scale electric vehicle systems and other large scale battery systems do not provide a method for detecting various power bus isolation fault conditions combined, in both battery system connected and disconnected modes, with a safe bus discharging mechanism.

Current large scale electric vehicle systems and other large scale battery systems do not provide a method of adjusting output current limits during operation based on state of charge (SOC), state of health (SOH), and state of life (SOL) parameters by using feedback signals.

Embodiments of the present invention provide an electric vehicle power system including a battery system, a bus configured to transfer power to a motor drive, and a control circuit to selectively couple the battery to the bus. The control circuit is configured to discharge capacitance of the bus to a chassis in response to a disconnect between the battery and the bus. Further, the control circuit measures impedance across the bus. As a result, the control circuit can monitor integrity of the bus and detect a fault, such as a short circuit or degraded bus insulation.

In further embodiments, the control circuit measures impedance across the bus over a time interval following the disconnect. The battery system may further include a battery management unit configured to monitor status of a plurality of power cells within the battery system. The power system may further include a host controller that limits a discharge current to the motor drive based on the status. The status may include a battery state of charge, state of health, and state of life.

In still further embodiments, the control circuit may be configured to determine a fault in the integrity of the bus based on the measured impedance across the bus. In response to the fault, the control circuit may disconnect the battery from the bus. The control circuit may measure a metric, such as AC impedance and DC resistance, between the battery and a chassis. Similarly, the control circuit may measure a metric, such as AC impedance and DC resistance, between the bus and a chassis. Based on this metric, a fault may be determined, the fault indicating an insulation failure, a short circuit condition, or another failure.

Embodiments of the invention may include a high voltage front end (HVFE) circuit with multiple configurations and measurement modes, one of which can discharge charge stored in capacitance between power bus and chassis during times when the bus is not connected to the battery.

A further embodiment includes a HVFE circuit configuration and measurement mode to verify that the power bus is in a discharged state.

Another embodiment of the invention is a HVFE circuit configuration and measurement mode to monitor AC impedance (capacitance) to identify high voltage bus insulation health and possible onset of insulation failure.

Another embodiment of the invention is a HVFE circuit configuration and measurement mode to monitor AC and DC resistance from both battery terminals to chassis and from both power bus terminals to the chassis to detect a possible insulation failure or short circuit fault conditions.

Another embodiment of the invention is a method to communicate a current limit to a vehicle electronic control module such as a motor control unit to enable feedback control of discharge current limits in accordance with BMSHC determined SOC, SOH, and SOL levels.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates a battery module that may be implemented in embodiments of the present invention.

FIG. 2 illustrates a string including a plurality of battery modules.

FIG. 3 is a block diagram of a battery pack including embodiments of the present invention.

FIG. 4 is a block diagram of a power bus for providing power to a motor drive.

FIG. 5A is a circuit component of a high-voltage front end (HVFE) for discharging a bus.

FIG. 5B is a circuit component of a HVFE for measuring impedance.

FIG. 6 is a detailed schematic of a HVFE control circuit.

FIGS. 7A-C are waveforms illustrating measurement functions of a HVFE.

FIG. 8 is a flow diagram illustrating a method of operating an electric vehicle according to one embodiment.

### DETAILED DESCRIPTION OF THE INVENTION

A description of example embodiments of the invention follows.

Embodiments of the invention relate to control of large scale electric vehicle battery systems. Some embodiments of the invention, described below, provide power bus discharging and fault monitoring for and within the battery system to improve power system safety and performance.

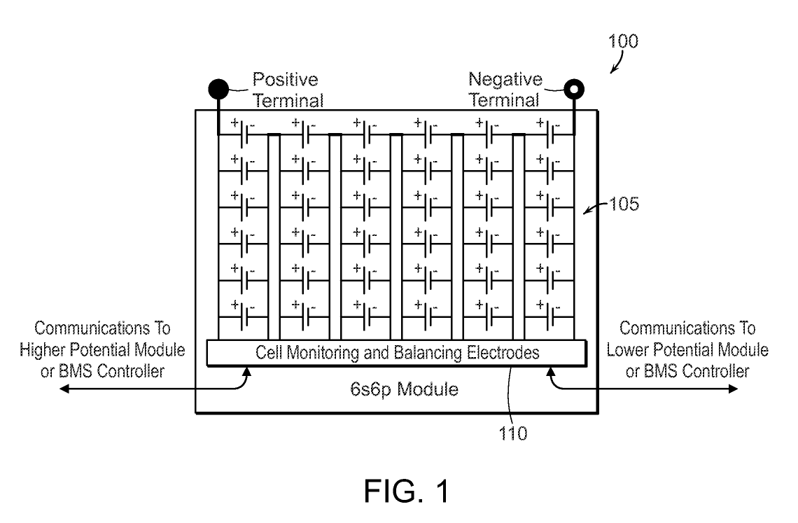

FIG. 1 illustrates a battery module 100 that may be implemented in embodiments of the present invention. The module 100 includes a block 105 of battery cells. The block 105 may include a plurality of battery cells in one or more configurations, such as an arrangement of plural arrays of battery cells connected in series, where each battery array further includes a plurality of battery cells connected in parallel, as shown. Each module 100 also includes a module controller 110, which may be a microcontroller or an application specific integrated circuit (ASIC). If the battery module 100 is configured in a hierarchical configuration of battery modules, the module controller 110 may communicate with other module controllers (not shown) or a host controller as described below. The module controller 110 may be configured to perform a number of functions, independently or in response to a command from a host controller or other unit:
1. Analog to digital (A/D) conversion of block voltages.
2. Sample block voltage (e.g., at the request of a host controller).
3. A/D conversion of block temperature sensor inputs.
4. Alarm reporting based on configurable alarm parameters.
5. Switch control of block balancing circuit based on commands from the host controller and configure current/timing parameters.
6. Switch control of an optional module safety device based on internal fault detection and/or commands from the host.

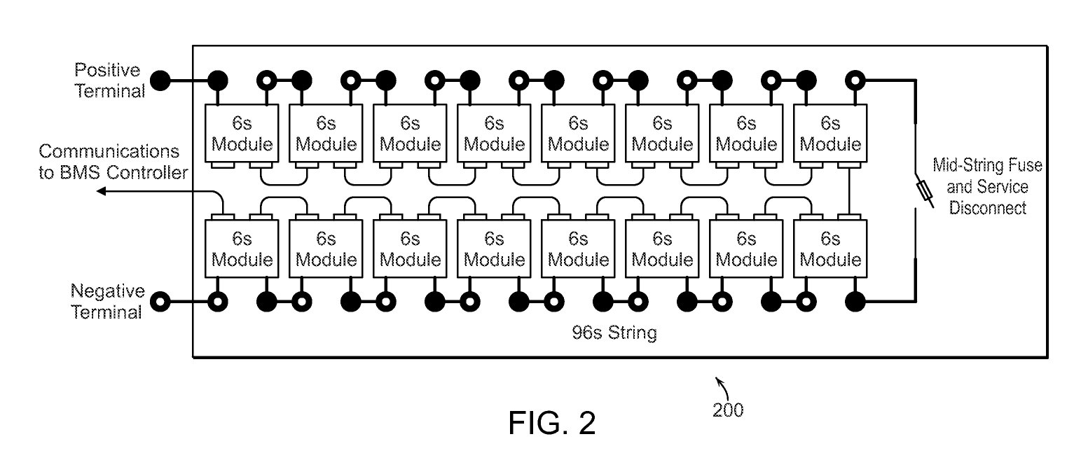

FIG. 2 illustrates a battery string, which includes a plurality of battery modules 100 (as shown in FIG. 1) arranged in a series configuration. A communications link to a host controller (not shown) may be connected to each of the battery modules in a daisy chain cascade.

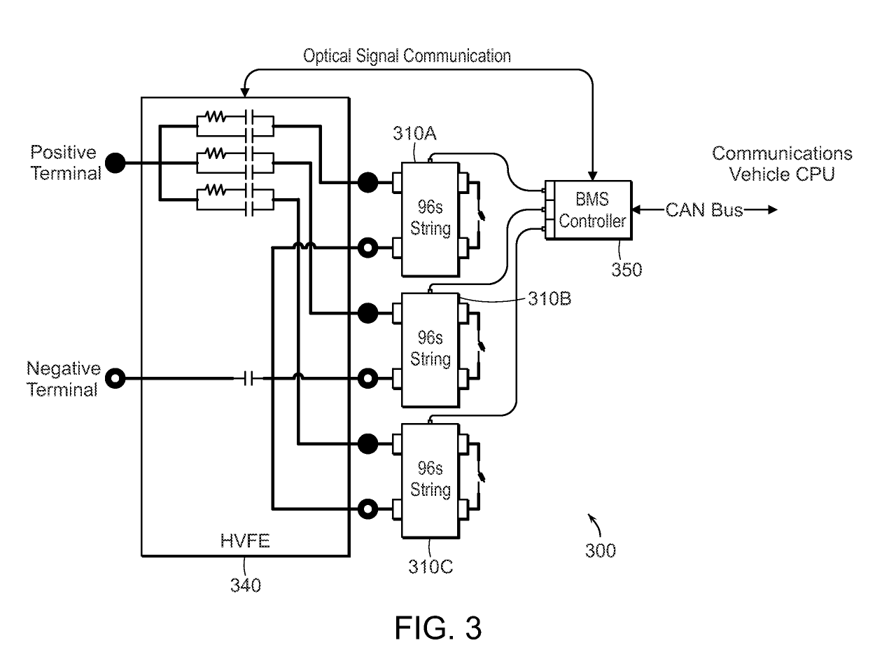

Large scale battery systems may be comprised of a plurality of battery modules (e.g., battery module 100 as shown in FIG. 1), battery strings (e.g., battery string 200 as shown in FIG. 2), or other arrangements of battery cells, with additional circuitry for monitoring and controlling operation of the batteries. Such arrangements may be referred to as battery “packs,” and are described below with reference to FIG. 3. Battery packs may be comprised of an array of series and parallel cells with additional control circuitry. A group of individual cells connected in parallel is comprises a “block.” A block or group of blocks connected in series and packaged together with monitoring and balancing electronics is a module, an example of which is described above with reference to FIG. 1. A group of modules connected in series is a string, an example of which is described above with reference to FIG. 2. Further, multiple strings maybe connected in parallel with individual fuses and/or contactors to form a battery pack, an example of which is described below with reference to FIG. 3. For each string, fuses may be rated for the maximum string voltage and current. Contactors may be rated for the maximum system voltage and current.

In these large scale battery systems, mechanical and electronic controls may be implemented to optimize performance and safety. If such controls are designed and implemented properly, the pack will have performance and safety characteristics approaching that of the individual cells it contains. A battery management system (BMS) control electronics' architecture may be configured as a master/slave type distributed processing system. Such a system includes a single master processor, hereafter referred to as the BMS Host Controller (BMSHC), in communication with a plurality of battery module controllers.

FIG. 3 illustrates a battery pack 300. The battery pack 300 includes a plurality of battery strings 310A-C, connected in parallel at a high-voltage front end (HVFE) 340. The HVFE 340 selectively couples the battery strings 310A-C to a bus (not shown), and performs additional diagnostic and control functions as described below. A battery management system host controller 350 is communicatively coupled to battery module controllers (not shown) located at each of the battery strings 310A-C.

The BMS Host Controller 350 may be configured to perform a variety of functions relating to the safety and performance of the battery pack 300. Several types of data may be sampled periodically from the module controllers, including block voltages, block temperatures and module alarms. The host controller 350 performs signal conditioning and analog to digital conversion (ADC) of all string current sensor inputs. The host controller further collects available high voltage front end (HVFE) 340 data, which may include string voltages, contactor temperature, contactor status, interlock status and insulation fault status. The host controller 350 provides output signals as open collector outputs for control of the HVFE 340, such as precharge and bus positive contactors, open collector output for control of bus negative contactor, and open collector outputs for cooling system control. The host controller 350 may further provide 2 Hz pulse width modulated (PWM) output signals indicative of calculations relating to the state of the constituent battery cells, including State of charge (SOC), discharge pulse power available, regenerative braking pulse power available and constant current charging rate.

Performance of a battery cell (and, in turn, a battery assembly of which it is a component) is typically measured by the energy delivered per cycle over the life of the battery. To measure and predict this performance, battery temperature, voltage, load profile, and charge rate may be detected. These measured values can be used to estimate three important parameters: 1) State of Charge (SOC), 2) State of Health (SOH), and 3) State of Life (SOL). These parameters indicate how the battery is performing in real-time. The accuracy of these estimations is dependent on a number of system design elements including accuracy and resolution of the temperature, voltage, and current measurements; sampling rate of the above measurements, and precision of the data used to predict the theoretical performance of the battery.

The BMS host controller 350 provides a controller area network (CAN) bus interface to vehicle with support for the following messages: Fault warnings, Fault alarms, SOC, State of health (SOH), State of life (SOL), Contactor status, Interlock status, Highest block temperature, Lowest block temperature, Average block temperature. The BMS host controller CAN performs block impedance calculations. Those contain calculation algorithms for SOC, SOH, SOL, and block balancing control with temperature and impedance compensation. During battery rest periods (i.e., no charge or discharge current flow) the BMS host controller 350 periodically calculates impedance (timing is configurable) using the cell balancing controls to produce a known current and measure voltage. The BMS host controller determines and acts on both configurable and non-configurable fault conditions.

Voltage measurements in the battery pack 300 may be taken at the cell level. The performance of a battery pack is limited by the weakest cell in the system; therefore, performance estimations must be made using the voltage of the weakest cell. Further, the location of the weakest cell in the pack may change over time; thus, all cell voltages must be monitored. The voltage measurement accuracy is primarily a function of the analog to digital converter (ADC); however, it is also affected by the implementation of the measurement connections. The distance from the cell terminal to the input of the ADC should be minimized to avoid electromagnetic interference (EMI). Passive filter circuits can also be employed to minimize EMI if necessary. The voltage measurement path may consist of wires, connectors, and/or copper traces on a printed circuit board (PCB). If any portion of that path is also used to carry current, the voltage drop due to that current will also affect the accuracy of the voltage measurement. Resistance of any current carrying paths should be low enough that the voltage drop under full load is negligible.

Temperature, like voltage, may be measured at the cell level or as close as possible to provide the best performance estimation accuracy. The capacity and cycle life of a battery cell are significantly impacted by temperature. Some cells may become hotter than others, and so a measurement of individual cells may be beneficial in estimating the performance of the entire pack.

The temperature of groups of cells that are in thermal contact with each other can be used in instances where the temperature of each cell cannot be measured directly. A commonly used way to measure temperature is with a voltage-biased negative temperature coefficient (NTC) thermistor device. This method provides a voltage that is proportional to the temperature of the thermistor and can be measured with an ADC. The distance from the thermistor to the input of the ADC should be minimized to avoid electromagnetic interference (EMI). Passive filter circuits can also be employed to minimize EMI if necessary.

Cell voltages and pack current should be sampled simultaneously in order to accurately measure AC impedance. Synchronization of cell voltage and the pack current sampling is critical to AC impedance measurements. Factory qualification impedance data for the Swing cells is standard 1 kHz AC impedance measurements, therefore the BMS should be capable of taking two consecutive data samples within 1 ms. In this case, impedance measurements may be made only during periods of changing current. During continuous charging it is necessary to vary current occasionally in order to take impedance measurements. During discharge, multiple sample sets may be taken, adhering to the following: 1) The minimum change in current required for an acceptable impedance measurement must be greater than the resolution of the current sensor. 2) The sample set with the greatest change in current should be used to provide the greatest accuracy. The timing of temperature measurements is less critical, as the thermal mass of the system will limit the rate of temperature change.

There are a number of State of Charge (SOC) estimation methods that can be used with LiIon battery chemistry including Coulomb counting and voltage-based estimation. Coulomb counting is achieved by monitoring the pack current and deriving SOC by adding or subtracting Ah's from the initial value. The major difficulty with this method is determining the battery's total capacity in real-time. This problem is addressed by using a look-up table with the battery's theoretical impedance vs. capacity curves at a variety of temperatures to interpolate the real-time capacity from real-time impedance measurements. Another drawback to this method is that the accuracy is limited by the current sampling frequency.

In the Voltage-based estimation method, theoretical charge and discharge voltage vs. SOC curves for the battery at a number of temperatures and rates are stored in a look-up table and SOC is interpolated from the voltage of the weakest cell. There are two difficulties with this method that must be addressed. The cell voltage may vary by <200 mV between 25% and 75% SOC during storage and low rate discharging which limits accuracy. During the constant voltage (CV) charge period, the SOC cannot be determined, as the voltage is fixed.

To address the limitations of the two aforementioned methods, one SOC estimation approach commonly utilized in LiIon HEV and PHEV applications is to combine the methods as follows. During CV charging coulomb counting can be used as the rate of change in current is steady thereby reducing the required current sampling rate. During storage and low-rate discharging when the SOC is between 25% and 75%, coulomb counting may be used to verify the accuracy of the voltage-based estimation. Voltage-based estimation may be used under all other operating conditions.

State of Health (SOH) is defined as a ratio of the battery's real-time capacity to its capacity before it has been cycled. The best approach for SOH estimation is to configure the system with the battery's theoretical capacity and compare this value with the real-time capacity. Real-time capacity is determined by using a look-up table with the battery's theoretical impedance vs. capacity curves at a variety of temperatures to interpolate the real-time capacity from real-time impedance measurements.

State of Life (SOL) is defined as the number of complete discharge cycles remaining before the battery's total capacity has faded to below a configurable level (typically 80% of the theoretical capacity). SOL is estimated by using a look-up table with cycle-life vs. capacity curves for a variety of temperatures to interpolate SOL from the real-time capacity estimations. Note that SOL is really a prediction more than it is an estimate, therefore it may increase or decrease as the operating conditions of the battery change over time.

The ability to balance charge between cells and modules in an electric vehicle battery pack is an important capability to enable high pack performance. A single weak element that loses capacity through aging or cycling in a lithium ion battery pack can prevent the rest of the pack from providing its full performance. When one cell of a series string hits its minimum voltage during discharge before the rest of the pack, the pack must cut off discharge while there is significant energy left in the good cells. Balancing techniques employed are typically passive or active. Passive techniques involve discharging overcharged (higher voltage) cells through a dissipating resistor. This process has the disadvantage of waste heat generation. Active balancing techniques are more energy efficient and typically employ switched capacitor networks to transfer charge to neighboring cells (see, e.g., U.S. Patent Pub. 2005/0024015, the entirety of which is incorporated herein by reference) or transformer coupling to transfer charge to the entire module string.

As battery packs become larger and exhibit greater capacity, it becomes important for safety and performance to monitor the condition and status of the power bus, in particular to provide bus isolation fault monitoring. In addition, it is important to discharge and verify adequate discharge level of the power bus when it is not connected to the battery.

A further optimization of performance may be achieved by controlling battery output current limits based on characteristics of the battery system. Such characteristics can include SOC, SOH and SOL, and can be indicated by a feedback signal to an external system using CAN bus or other I/O communications. (Data communication interface systems such as CAN bus are used to enable communication between a vehicle's various control units.) Thus, output current to a motor drive may be limited based on a status of the batteries within the power system. With reference to FIG. 3, for example, the BMS host controller 350 may communicate a current limit, via the CAN bus, to a vehicle electronic control module (not shown) such as a motor control unit. This communication enables feedback control of discharge current limits in accordance with SOC, SOH, and SOL levels as determined by the BMS host controller. In one example, battery SOC may be used to provide a current limit feedback to the load at the motor drive (e.g., a motor assembly for driving the electric vehicle), meaning that the current limit is decreased as a function of the SOC as the SOC decreases over time. In other embodiments, other parameters, such as the battery SOH and SOL as measured and estimated by the BMS host controller, are used to limit battery current. For example, if the BMS host controller determines that the battery cells have aged (i.e., decreased SOL) to a threshold limit with a reduced level of SOH, then the BMS host controller can lower the maximum battery current limit. PWM signals that control each motor's torque and speed of rotation are adjusted to reflect the lower current limit.

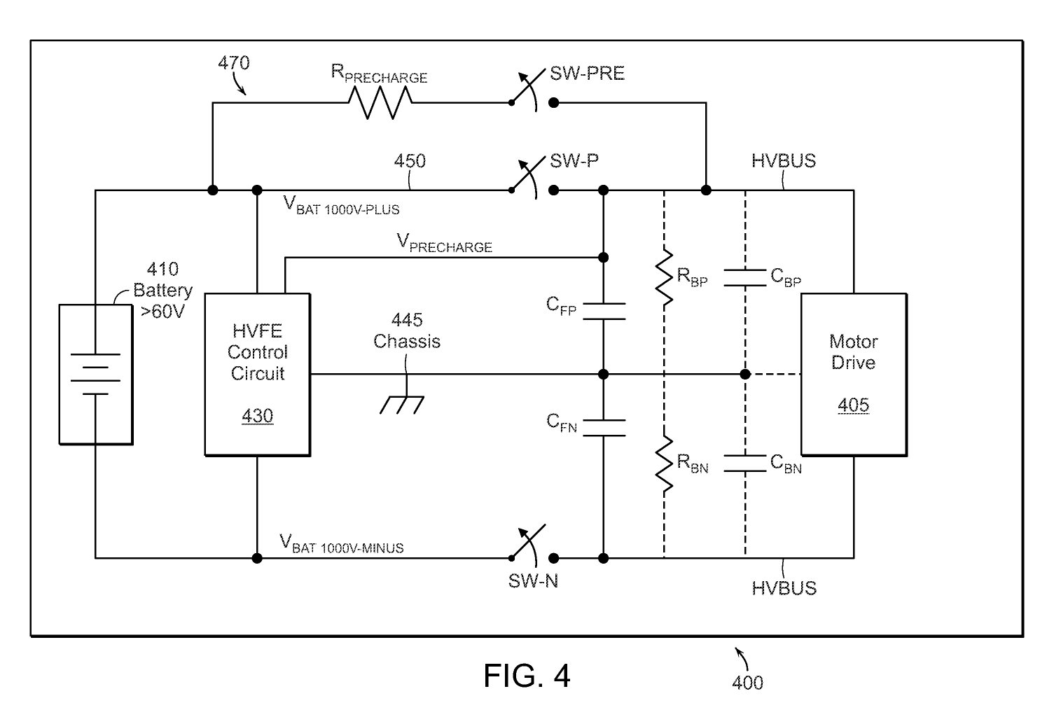

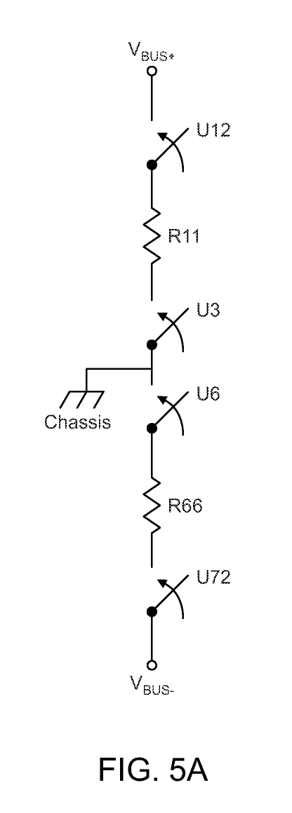

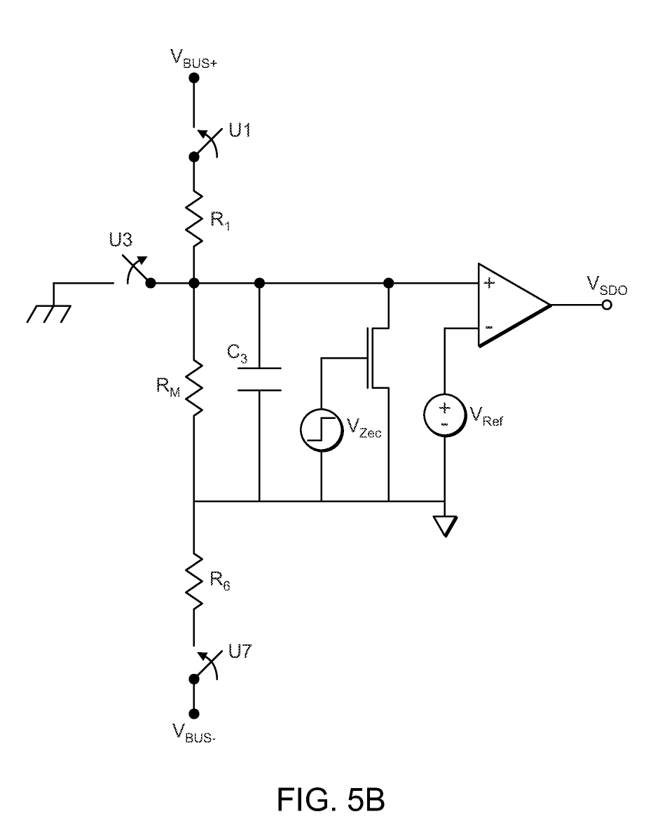

FIG. 4 is a block diagram of a power system 400 for providing power to a motor drive 405. The power system 400 includes a battery 410 (which may include an arrangement of battery cells and associated circuitry as described above with reference to FIGS. 1-3), a power bus Vbus 450, a HVFE control circuit 430, and an arrangement of contactors (SW-PRE, SW-P, SW-N) that are components of the HVFE. The HVFE control circuit 430 connects to the positive and negative battery terminals, V_Bat+ and V_Bat−. In addition, the HVFE control circuit 430 provides a direct connection to the power bus 450 via the line Vprecharge, selectively bypassing the main power bus contactors SW-P and SW-N (described in further detail below with reference to FIGS. 5A-B and 6). This direct connection to the power bus 450 enables the HVFE control circuit 430 to monitor and discharge the power bus 450 when the main power bus contactors SW-P, SW-N are open. The HVFE control circuit 430 further provides a connection to the vehicle chassis 445.

A bus precharge circuit 470 enables the system 400 to equalize the voltage between the battery terminals Vbat and the power bus 450 prior to closing the main power bus contactors SW-P, SW-N. When the BMS host controller (not shown) commands the HVFE to close the power bus precharge switch SW-PRE, charge flows from the battery 410 to the power bus 450 and the current limited precharge resistor R_Precharge, until the bus voltage is equal to the battery voltage, and thus the bus is charged.

Capacitances C_FP and C_FN represent the combined capacitance of filter capacitors associated with the battery 410 and motor drive 405. Capacitances C_BP and C_BN represent the combined distributed capacitance of the power bus 450 to the chassis 445 and, for example, include capacitance across the power bus insulation. Resistances R_BP and R_BN represent the combined distributed resistance of the power bus 450 to the chassis 445 and, for example, include resistance across the power bus insulation.

The HVFE control circuit 430 provides a number of functions in addition to connecting and disconnecting the battery 410 to the power bus 450. The HVFE control circuit controls discharging of charge stored in capacitance between power bus 450 and chassis 445 during times when the bus 450 is not connected to the battery 410. The HVFE control circuit 430 further verifies that the bus is discharged.

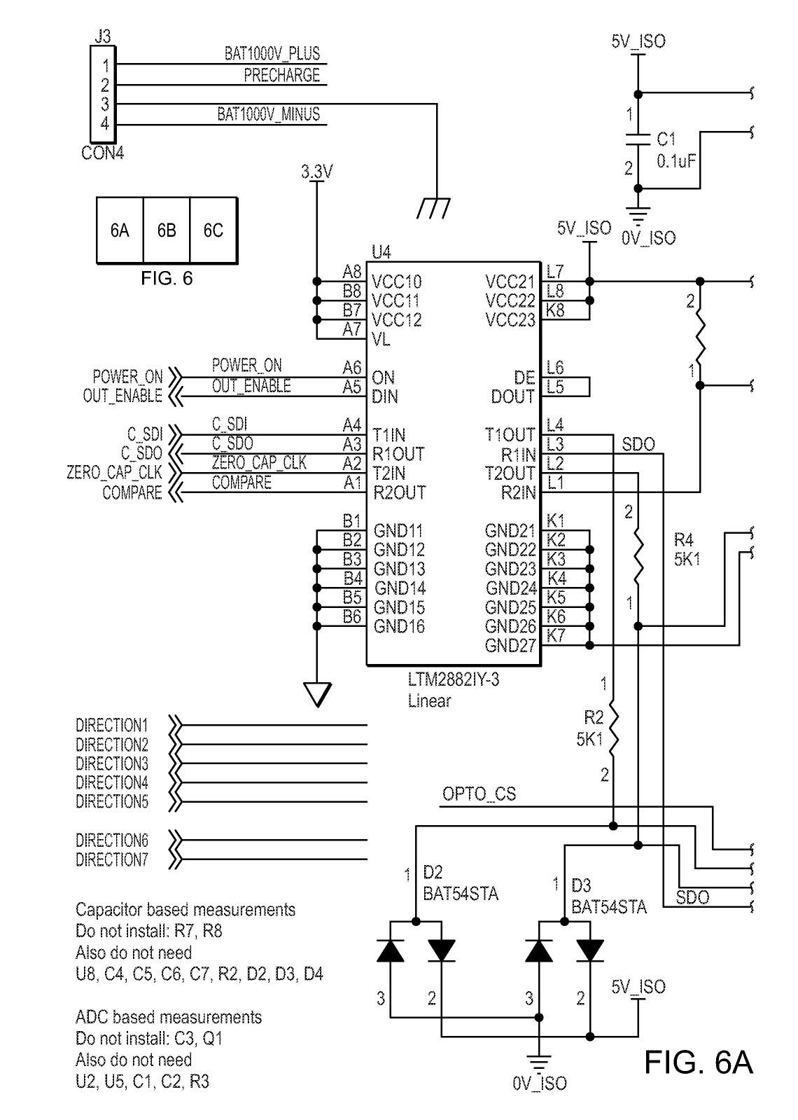

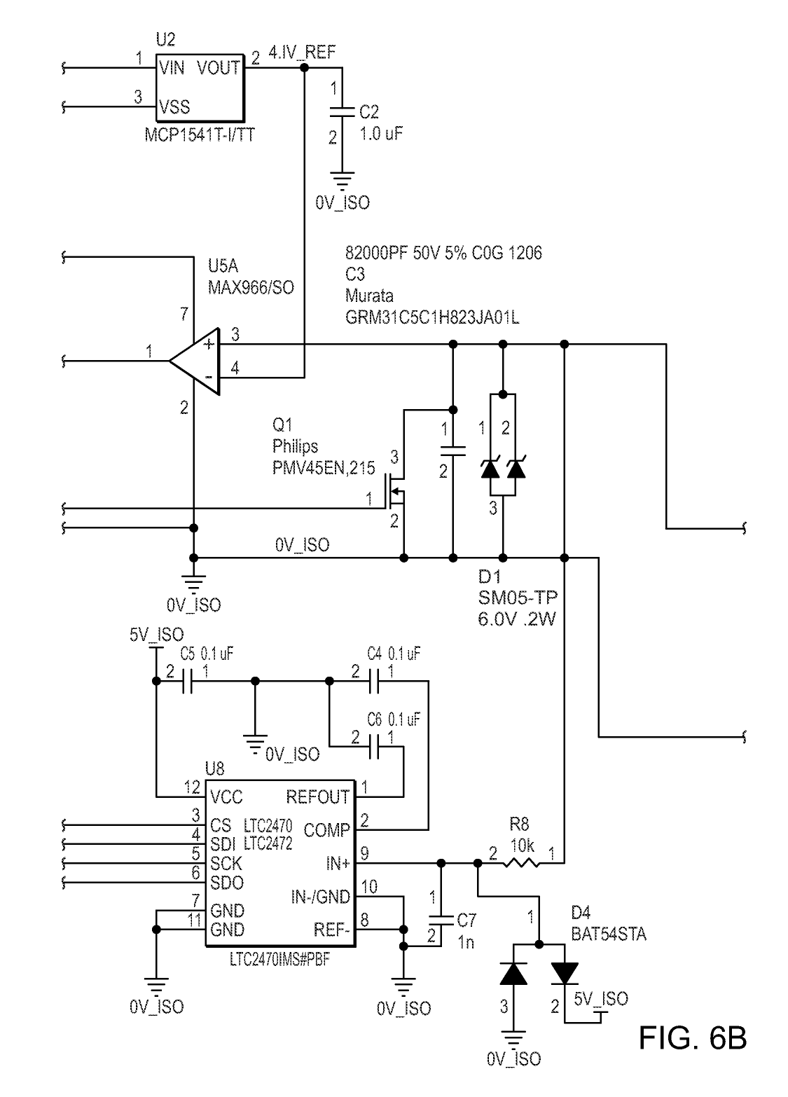

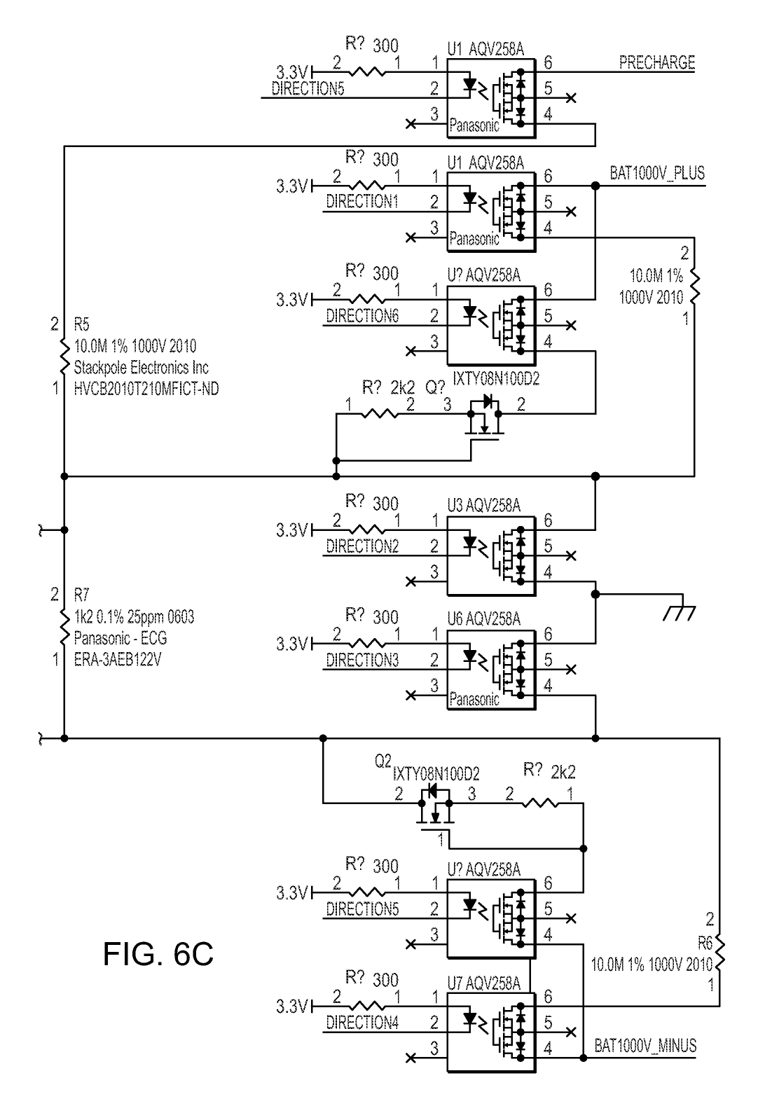

In addition, the HVFE control circuit 430 monitors AC impedance (capacitance) to determine the health of the insulation of the power bus 450 and possible onset of insulation failure. The HVFE control circuit 430 also monitors AC and DC resistance from both battery terminals Vbat to chassis 445, and from power bus terminals Vbus to the chassis 445, to detect a possible insulation failure or short circuit fault conditions. A detailed schematic of a HVFE control circuit is described below with reference to FIG. 6, and portions of such a circuit, with attention to the functions indicated above, are described below with reference to FIGS. 5A and 5B.

FIG. 5A shows a portion of a HVFE control circuit, based on the HVFE control circuit in FIG. 6, that enables discharge of charge stored in the capacitances between power bus and chassis. With reference to FIG. 4, the capacitances that are discharged by the FIG. 5A circuit are C_FP, C_FN, C_BP and C_BN. The power bus may be discharged during all times when the bus is not connected to the battery (i.e., when contactors SW-P and SW-N in FIG. 4 are open). Referring back to FIG. 5A, the BMS host controller (not shown) indicates to the HVFE to close switch elements U12, U3, U6 and U72. The switch elements may be implemented using an optically isolated solid state power transistor (e.g., Panasonic model AQV258A) or, alternatively, using a mechanically actuated relay switch or by a similar electrical switching element. When the aforementioned switch elements are closed, current flows through discharge resistors R1 and R6 between V_Bus+, V_Bus−, and the chassis until the bus voltages V_Bus+ and V_Bus− are at the same voltage level as the chassis. Resistors R11 and R66 may be selected to withstand a voltage drop of greater than the highest bus voltage level and be of resistance value with power rating greater than the power dissipated by the largest bus voltage (e.g., resistors having 10.0 M Ohm resistance and 1000V maximum voltage rating).

FIG. 5B shows a portion of a HVFE control circuit, based on the HVFE control circuit in FIG. 6, that enables monitoring of AC impedance (capacitance) to identify high voltage bus insulation health and onset of insulation failure. The bus impedance is measured using a switched RC network that charges with a time constant proportional to the positive or negative bus capacitances, C_BP or C_BN respectively. Although the circuit of FIG. 5A illustrates a connection to the power bus Vbus, the circuit may be switched to span the battery terminals Vbatt+ and Vbatt− to measure AC impedance and DC resistance across the battery, via an alternative configuration as described below with reference to FIG. 6. A voltage comparator circuit USA, operating as a detector to detect the time to charge to a reference voltage, triggers an output signal V_{SDO} when the RC network reaches a voltage equal to a reference voltage level V_ref. The AC impedance monitoring mode is enabled when the BMS host controller (not shown) indicates to the HVFE to open switch U3. Switch U1 is then closed to monitor positive side capacitance C_BP, or switch U7 is closed to monitor negative side impedances C_BN. For diagnostic purposes, both U1 and U7 may be opened to monitor the known measurement impedance R_M in parallel with C_3. In addition, for diagnostic of the chassis voltage, switches U1 and U7 may be opened, and switch U3 may be closed.

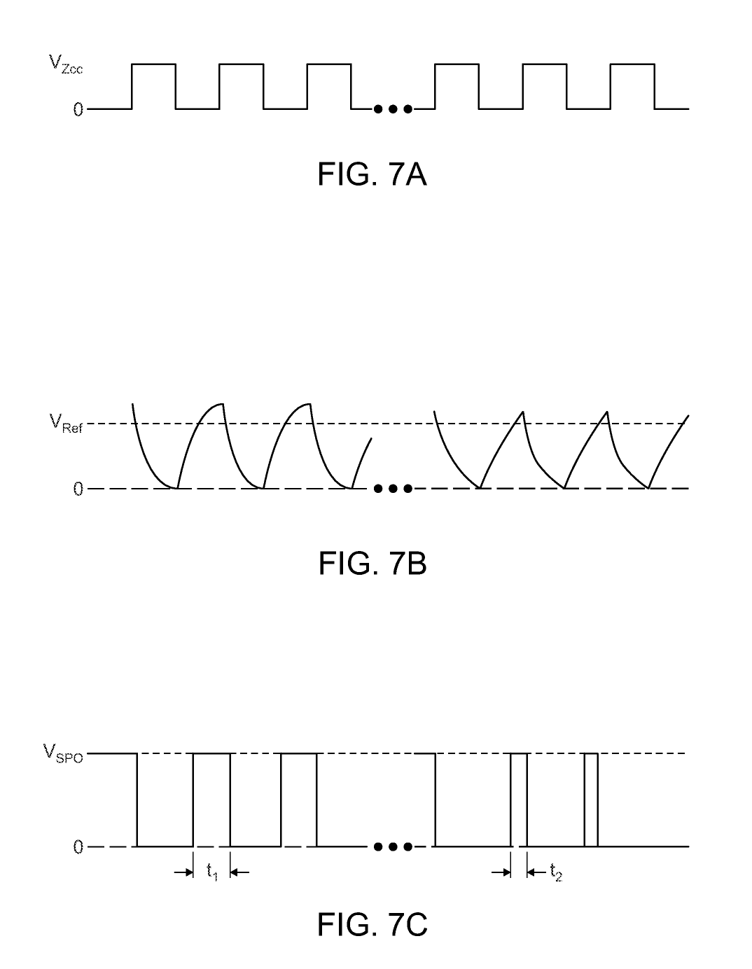

Once the proper configuration of FIG. 5B switches is actuated according to the desired measurement to be taken, the BMS host controller provides a digital drive signal V_ZCC to “zero” the charged capacitance. The high level of V_ZCC should be sufficient to place the zeroing transistor in the conducting state. The low level of V_ZCC should place zeroing transistor in the non-conducting state. A typical digital drive signal is shown in FIG. 7A. The frequency of the drive signal is chosen to be equal to or larger than the expected RC time constant of a healthy power bus.

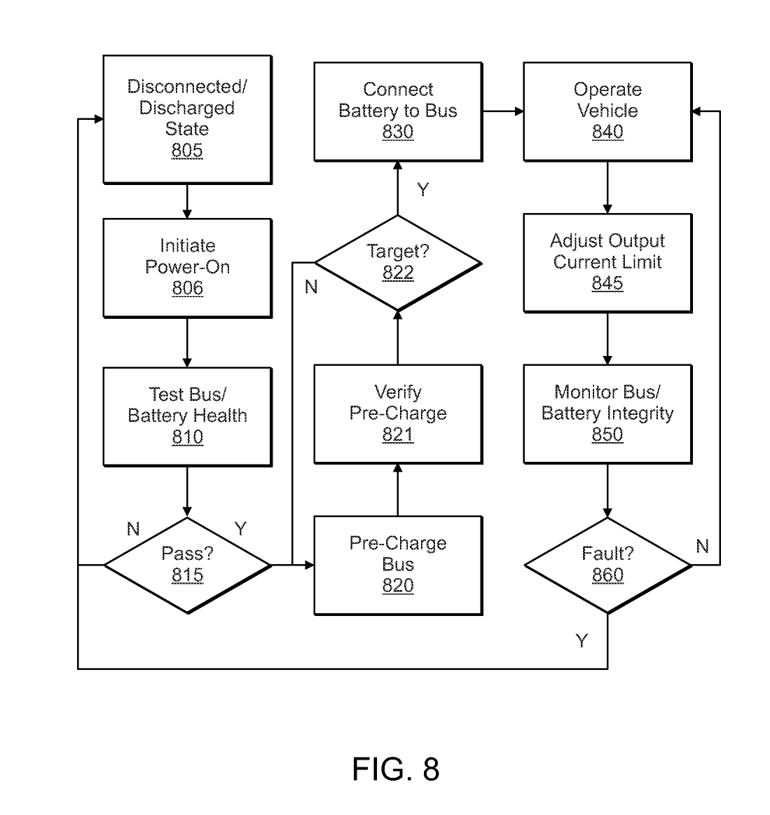

The circuit of FIG. 5B operates as follows, given that switch U3 is open, switch U1 is closed and switch U7 is open. When input digital drive V_ZCC is high, then the zeroing transistor is conducting, and all bus capacitance discharges through the zeroing transistor and the comparator is clamped to a low output level. The capacitance is thus “zeroed”. When input to digital drive V_ZCC is low, the zeroing transistor is not conducting and the bus capacitance charges with RC time constant (R_M+R_BP)* (C3+C_BP). FIG. 7B shows a typical charging and discharging waveform across the measurement capacitance C3. Output V_SDO on comparator is low until the measurement voltage across R3 reaches the V_Ref level at which time the comparator switches to high level. Typical output of the comparator is shown in FIG. 7C. When a change in the bus capacitance C_BP occurs, possibly due to the onset of insulation failure or other damage to the bus insulation, the measurement time constant changes and similarly the amount of time that comparator is on changes. The effect of a change in bus capacitance is shown in FIGS. 8 A, B and C between the left side and right side of the figure. On the left side, the comparator switches on for a time interval t1, while on the right side the comparator is only on for time interval t2. A timer, located in the BMS host controller and monitoring the comparator output level V_SDO, is one way to measure the time interval. If the time interval lies in a certain range or above a certain level, this can be correlated to a change in bus capacitance due to insulation failure or damage.

Another feature of the AC impedance measuring circuit in FIG. 5B is a configuration to measure impedances in a desired range typical of power bus insulation capacitances while not being sensitive to other capacitances such as due to filters in the motor drive. This is accomplished by incorporating a reference capacitance C3 and reference resistor R_M whose values are comparable to the expected power bus resistance R_BP and capacitance C_BP. The frequency of the zeroing transistor drive signal is chosen to detect the measurement RC time constant. When the bus capacitance or resistance changes the time constant change will be on the order of the measurement RC time constant. Other impedances much smaller or larger than the bus to chassis impedance, such as for example due to filtering capacitors in the motor drive circuit, will not significantly change relative the measurement RC time constant.

FIG. 6 shows a detailed schematic of HVFE control circuit. The HVFE control circuit provides an isolated digital communication interface using SPI isolation buffer U4. Digital communication between the BMSHC and the HVFE circuit passes through the isolation buffer U4. Communication channels through U4 are provided for SPI signals to the analog-to-digital converter (ADC) U8, Zeroing capacitance clock signal to zeroing transistor Q1, comparator USA output, power on signal, and enable output signal.

In a further operational mode, the HVFE monitors AC impedance and DC resistance between 1) the battery terminals and the chassis and 2) the power bus terminals and the chassis. The monitoring enables detecting one or more fault conditions, such as an insulation failure or short circuit, and may be indicated by the ADC U8. The ADC U8 provides a digitized measurement of the instantaneous analog voltage level at the comparator input and across the measurement impedance (C3 and R_M) in FIG. 5B. When the main contactors connect the bus to the battery, the voltage level provides an indication of the power bus DC and AC resistance to chassis. When the main contactors disconnect the power bus from the battery, U8 provides an indication of the battery terminals DC and AC resistance to chassis. For example, if the power bus were disconnected from the battery, active AC measurement mode was disabled, and U8 indicated a zero volt difference measured between battery positive terminal BAT1000V_Plus and the chassis, then a potential short circuit condition across battery positive terminal to chassis would be indicated. In addition, the ADC U8 can be used to verify that the power bus has been adequately discharged. For example, if the HVFE discharge mode described previously has been enabled, a zero voltage across the measurement impedance indicates that both positive and negative power bus rails have been discharged to the chassis level.

Zener clamp diode D1, shown in FIG. 7, may be used to protect and limit input voltage level on the comparator U5A. Diode D1 may be selected to have a clamp voltage smaller than the maximum input voltage allowable across the comparator, and larger than the highest voltage expected across the measurement capacitor. The clamp could be used to prevent an erroneous measurement condition. For example, if both switches U1 and U7 are closed simultaneously, then the entire bus voltage would be present across the comparator and clamped to a safe level by D1.

Various solid-state switches control the configuration of modes in FIG. 6. Switch U0 enables a probe of V_PRECHARGE voltage level using a resistive divider across R5 and R7. This line is also used to detect the positive bus voltage when main contactors SW-N and SW-P are open.

The bus discharge configuration (FIG. 5A) is enabled by actuating switches U12, U3, U6 and U72, thereby placing resistors R11 and R66 as a discharge path from the bus lines to the chassis. The bus is may be discharged to the same voltage level as the chassis. AC and DC impedance measurement modes (FIG. 5B) are enabled by actuating switches U1 and U7 and opening switch U3.

FIG. 8 is a flow diagram illustrating a method of operating an electric vehicle according to one embodiment. The method may be completed by a power system and associated components as described above with reference to FIGS. 1-6, and in particular the HVFE control circuit described above with reference to FIGS. 4-6.

In a disconnected and discharged state 805, such as when the vehicle is powered off, the battery is disconnected from the power bus. The HVFE circuit enters a configuration as in FIG. 5A to discharge the power bus and verify that the bus is discharged by measuring the positive voltage level at the V_Precharge line. Further, the HVFE circuit may conduct a number of diagnostic tests to ensure the integrity of the power bus, the battery and associated hardware, including: verify the voltage at the battery terminals with respect to chassis to ensure no short circuit from a battery terminal to the chassis (DC resistance check); periodically verify that the bus is discharged to chassis (repeating the discharge operation if the bus is not verified to be discharged); verifying AC impedance of the battery terminals, thereby verifying the insulation health of the battery terminals; and verifying AC impedance of the positive bus terminal with respect to the chassis using the V_Precharge line. Such diagnostic tests are described above with reference to FIGS. 4-7.

In response to a user command (e.g., turning an ignition key), a power-on sequence is initiated 806. Prior to connecting the battery to the bus, the HVFE conducts a number of tests to verify the integrity of the bus and battery system 810. These tests may include those tests described above at the step of disconnected and discharged state 805. If the battery and bus are verified 815, then a pre-charge sequence is initiated in order to raise the voltage of the bus to a level comparable to the battery voltage 820. The pre-charge is verified 821, and, if the bus voltage reaches a target voltage 822, then the HVFE connects the battery to the bus 830. Here, when the precharge is disconnected, the bus voltage may be verified using V_PRECHARGE, thereby verifying that the positive bus contactor is working properly. In this state 830, a user may operate the vehicle 840, employing the battery to power the vehicle motor drive. During this operation, the BMC host controller may adjust an output current limit to the motor drive based on a measured or calculated battery SOC, SOH and/or SOL 845. Further, the HVFE control circuit may continuously or periodically monitor the integrity of the bus and battery 850. In this state, the HVFE circuit may conduct a number of diagnostic tests, including: an AC impedance check of V_BAT1000V_PLUS-to-chassis to verify positive bus side insulation health or detect impending failure; an AC impedance check of V_BAT1000V_MINUS-to-chassis to verify negative bus side insulation health or detect impending failure; a DC resistance check of V_BAT1000V_PLUS to detect if Bus positive has leakage resistance or is shorted to the chassis; and a DC resistance check of V_BAT1000V_MINUS to detect if the bus negative has leakage resistance or is shorted to the chassis.

If a fault is detected 860, then the battery may be disconnected from the bus to ensure the safety of the power system 805. Otherwise, if the bus and battery integrity are verified, then the vehicle may continue normal operation 840.

While this invention has been particularly shown and described with references to example embodiments thereof, it will be understood by those skilled in the art that various changes in form and details may be made therein without departing from the scope of the invention encompassed by the appended claims.

What is claimed is:

1. An electric vehicle power system, comprising:
a battery system;
a bus configured to transfer power to a motor drive; and
a control circuit configured to selectively couple the battery to the bus and monitor integrity of the bus, the control circuit:
discharging capacitance of the bus to a chassis in response to a disconnect between the battery and bus; and
measuring impedance across the bus.

2. The system of claim 1, wherein the control circuit measures impedance across the bus over a time interval following the disconnect.

3. The system of claim 1, wherein the battery system includes a battery management unit configured to monitor status of a plurality of power cells within the battery system.

4. The system of claim 3, further comprising a host controller configured, responsive to the status, to limit a discharge current to the motor drive.

5. The system of claim 4, wherein the status is one or more of a state of charge, state of health, and state of life.

6. The system of claim 1, wherein the control circuit is further configured to determine a fault in the integrity of the bus based on the measured impedance across the bus.

7. The system of claim 6, wherein the control circuit is further configured to disconnect the battery from the bus in response to the fault.

8. The system of claim 1, wherein the control circuit is further configured to measure a metric between the battery and a chassis, the metric being at least one of AC impedance and DC resistance.

9. The system of claim 8, wherein the control circuit is further configured to determine a fault based on the metric, the fault indicating at least one of an insulation failure and a short circuit condition.

10. The system of claim 1, wherein the control circuit is further configured to measure a metric between the bus and a chassis, the metric being at least one of AC impedance and DC resistance.

11. The system of claim 10, wherein the control circuit is further configured to determine a fault based on the metric, the fault indicating at least one of an insulation failure and a short circuit condition.

12. The system of claim 1, wherein the battery system includes a plurality of battery cells.

13. The system of claim 1, wherein the control circuit includes a switched resistor-capacitor (RC) circuit configured to charge with a time constant proportional to a capacitance across the bus, and a detector to detect a time to charge to a reference voltage.

14. The system of claim 13, wherein the control circuit selects the bus capacitance to one of a positive side bus capacitance and a negative side bus capacitance.

15. The system of claim 13, wherein the control circuit is configured to switch the RC circuit between a configuration to measure the impedance across the bus and a configuration to measure impedance across the battery.

16. The system of claim 13, wherein the control circuit is configured to switch the RC circuit to measure a voltage across the chassis.

17. The system of claim 13, wherein the control circuit is further configured to report a fault as a function of change in the bus capacitance.

18. The system of claim 1, wherein the control circuit is configured to switch between a plurality of modes of operation, the modes including:
discharging the bus capacitance; and
measuring impedance across the bus.

19. The system of claim 18, the modes of operation further including:
measuring impedance across the battery; and
measuring voltage across the chassis.
